(19) United States
(12) Patent Application Publication
(10) Pub. No.: US 2015/0326044 A1
(43) Pub. Date: Nov. 12, 2015

(54) BAG WITH POWER INTERFACE FOR MOBILE CONSUMER ELECTRONICS

(71) Applicant: M-Edge International Corp., Hanover, MD (US)

(72) Inventors: Adam R. ASHLEY, Crownsville, MD (US); Joshua B. KING, Linthicum Heights, MD (US); Christopher R. HELMAN, Linthicum, MD (US); Jonathan D. MCCUNE, Chester, MD (US)

(21) Appl. No.: 14/704,601

(22) Filed: May 5, 2015

Related U.S. Application Data
(60) Provisional application No. 61/989,175, filed on May 6, 2014.

(51) Int. Cl. H02J 7/00

(52) U.S. Cl. CPC H02J 7/0042; H02J 7/0054; H02J 2007/0062

(57) ABSTRACT

A charging device includes a bag having an interface opening, a battery disposed within the bag, and a battery interface module adapted to be electrically coupled to the battery. The battery interface module has an interface input port for connecting to an external power source and an interface output port for connecting to an electronic device. The battery interface module is disposed within the interface opening of the bag such that the input port and the output port are accessible from an exterior of the bag.

### CROSS-REFERENCE TO RELATED APPLICATIONS

This application claims priority under 35 U.S.C. §119 to U.S. Provisional Application No. 61/989,175, filed on May 6, 2014, which is incorporated by reference herein in its entirety.

### FIELD OF THE INVENTION

The present invention relates generally to a charging device for electronic devices incorporated into a bag or other carrying case.

### BACKGROUND OF THE INVENTION

Electronic devices have become smaller and more portable, and bags, luggage, cases, and other products have been provided to allow users to more conveniently carry their devices. Bags have been provided with a battery and corresponding interface included on the inside of the bag allowing users to charge their devices only when the devices are positioned inside the bag. Therefore, in order to charge their electronic devices with such bags, users would need to open the bag to access the battery and its corresponding interface to plug in their electronic devices. This makes using the electronic device while charging more difficult. It also is inconvenient for users to charge the electronic device because users would need to take off their bag in order to open it and access the battery.

### SUMMARY OF THE INVENTION

In an embodiment, the invention provides a charging device including a bag that includes an interface opening, a battery disposed within the bag, a battery interface module adapted to be electrically coupled to the battery, the battery interface module having an interface input port for connecting to an external power source and an interface output port for connecting to an electronic device, wherein the battery interface module is disposed within the interface opening of the bag such that the input port and the output port are accessible from an exterior of the bag.

A charging device according to the present application provides a convenient system for carrying electronic devices and for charging the devices when they are outside of the bag. According to various embodiments, a bag is provided with a battery and an interface that allows the user to charge an electronic device from the exterior of the bag while the battery is stowed safely on the interior of the bag. The power/charging interface is integrated into the exterior shell of the bag.

Bags constructed according to embodiments of the present application allow users to charge one or multiple devices using a battery provided inside the bag via a port accessible on the exterior of the bag without having to access the interior of the bag. Further, the battery may be charged by connecting to an external power source via the port on the exterior of the bag without having to access the interior of the bag. Thus, a user may charge the battery on the inside of the bag through the interface without having to open the bag to access the battery. In addition, the user may charge the battery of the electronic device by connecting the device to the battery via the port on the exterior of the bag without having to open the bag to access the battery.

The bag may include a chargeable battery that may be connected to a plurality of battery interface modules. The battery interface module includes an input port for charging the battery from an external power source. The battery interface module also includes at least one output port to charge the electronic devices. The battery interface module of the bag allows connections to the input port and the output port from the outside of the bag. The battery may be provided with a plurality of battery input ports and a plurality of battery output ports for connecting to the plurality of battery interface modules.

The interface may include an indicator which indicates when the electronic device is charging. The indicator may also provide a different indication when the battery positioned inside the bag is charging. Also, the indicator may provide the user with an indication as to the amount of charge remaining in the battery.

### BRIEF DESCRIPTION OF THE SEVERAL VIEWS OF THE DRAWINGS

FIG. 1 is a diagram depicting electrical connections of a charging device according to an embodiment;

FIG. 2 is a diagram depicting electrical connections of a charging device according to another embodiment;

FIG. 3 is a diagram depicting electrical connections of a charging device according to another embodiment;

FIG. 4 is a diagram depicting electrical connections of a charging device according to another embodiment;

FIG. 5 is a diagram depicting a perspective view of a messenger-type bag according to another embodiment;

FIG. 6 is a diagram depicting a front perspective view of a backpack-type bag according to another embodiment;

FIG. 7 is a diagram depicting a rear perspective view of a backpack-type bag according to another embodiment;

FIG. 8 is a diagram depicting a front perspective view of a briefcase-type bag according to another embodiment;

FIG. 9 is a diagram depicting a front perspective view of a tote-type bag according to another embodiment;

FIG. 10 is a diagram depicting a front perspective view of a duffel-type bag according to another embodiment;

FIG. 11 is a diagram depicting a front perspective view of a suitcase-type bag according to another embodiment;

FIG. 12 is a diagram depicting a front perspective view of a suitcase-type bag according to another embodiment;

FIG. 13 is a diagram depicting a front perspective view of a backpack-type bag according to another embodiment;

FIG. 14 is a diagram depicting a front perspective view of a backpack-type bag according to another embodiment; and

FIG. 15 is a diagram depicting a front perspective view of a backpack-type bag according to another embodiment.

### DETAILED DESCRIPTION OF THE PREFERRED EMBODIMENTS

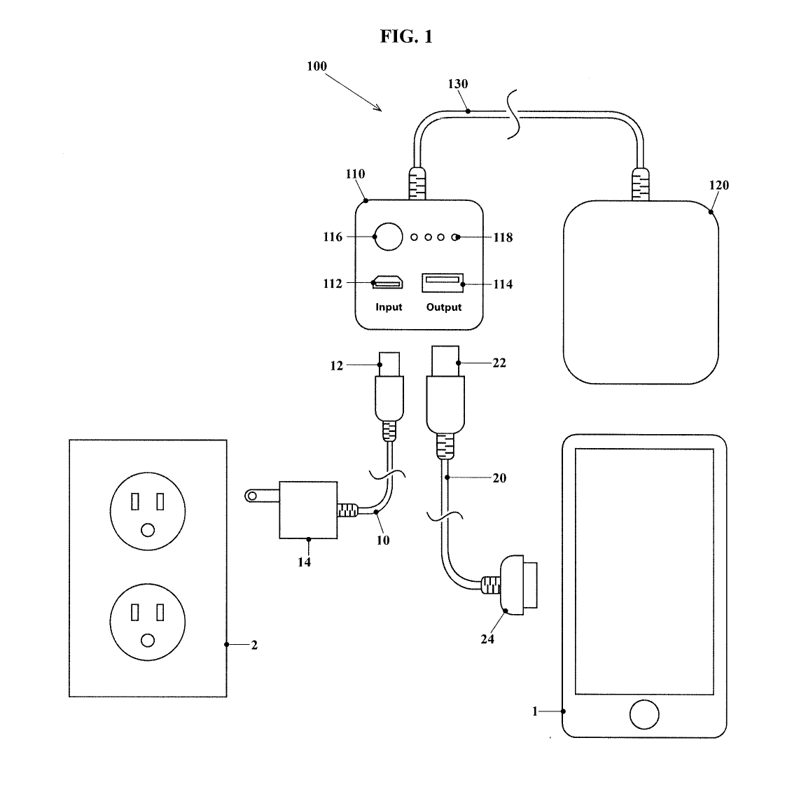

The exemplified charging device according to FIG. 1 includes an electrical system 100 for inclusion into a bag. Electrical system 100 includes a battery interface module 110 fixedly connected to a rechargeable battery 120 by a fixed cable 130. The battery interface module 110 includes an interface input port 112 that receives a first end 12 of a removable cable 10 that is connected to an external power source 2 at a second end 14 of the cable 10. Cable 10 connects the battery 120 to the external power source 2 via the interface module 110. The interface input port 112 may be a port for connecting to, for example, an alternating current power supply, a Universal Serial Bus (USB) connector, IEEE 1394 interface (FireWire™), or another suitable connector known in the art. While external power source 2 is shown as an alternating current wall outlet, external power source 2 may be any suitable source of power, including, for example, an output from solar power cells.

The battery interface module 110 also includes an interface output port 114 that receives a first end 22 of cable 20 that is connected to the electronic device 1 at a second end 24 of cable 20, thereby allowing the electronic device 1 to be charged by the battery 120 via the interface module 110. The interface output port 114 may be a port for connecting to, for example, a Universal Serial Bus (USB) connector, IEEE 1394 interface (FireWire™), or another suitable connector known in the art. A switch 116 is provided on the interface module 110. Switch 116 may be a power switch to thereby turn the battery 120 on and off. Switch 116 may also act as a status indicator, showing, for example, whether the battery 120 is charging, the amount of charge remaining in battery 120, and whether electronic device 1 is charging thereby discharging battery 120. For example, a fully charged battery 120 may be indicated when all of a plurality of indicator lights 118 are illuminated. In addition, the color of the status indicator lights 118 may change based on whether the battery 120 is being charged or not.

When charging the auxiliary battery 120, the external power source 2 is connected to the interface input port 112 of the interface module 110 via the cable 10. To charge the electronic device 1, the device 1 is plugged into the interface output port 114 of the interface module 110 via cable 20, and optionally, switch 116 may be activated.

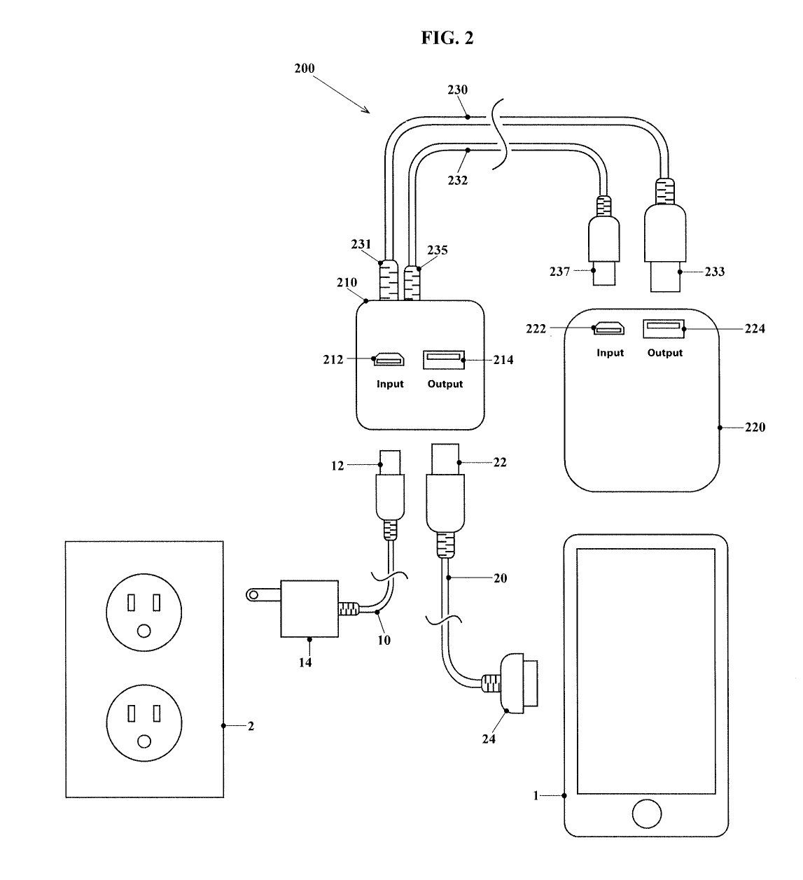

According to the exemplified charging device shown in FIG. 2, electrical system 200 includes a battery interface module 210 that is removably connected to battery 220. Battery 220 includes a battery input port 222 that receives a second end 237 of a removable cable 232 and a battery output port 224 that receives a second end 233 of a removable cable 230. The battery input port 222 and the battery output port 224 may be ports for connecting to, for example, Universal Serial Bus (USB) connectors, IEEE 1394 interfaces (Fire Wire™), or other suitable connectors known in the art. Accordingly, battery 220 may be removed from the system 200 and be replaced without requiring the replacement of other components, such as the interface module 210. The configuration also permits a user to provide a suitable battery 220 of their choice, without being tied to any particular manufacturer. Battery interface module 210 may also be provided with a switch (not shown) as described above with respect to the interface module 110 of FIG. 1.

When charging the auxiliary battery 220, the external power source 2 is connected to the interface input port 212 of the interface module 210 via the cable 10, and cable 232 is connected to the battery input port 222 of battery 220. To charge the electronic device 1, the device 1 is plugged into the interface output port 214 of the interface module 210 via cable 20, and cable 230 is connected to the battery output port 224 of battery 220. Optionally, a switch (not shown) in interface module 210 may be activated to then charge the device 1 or battery 220.

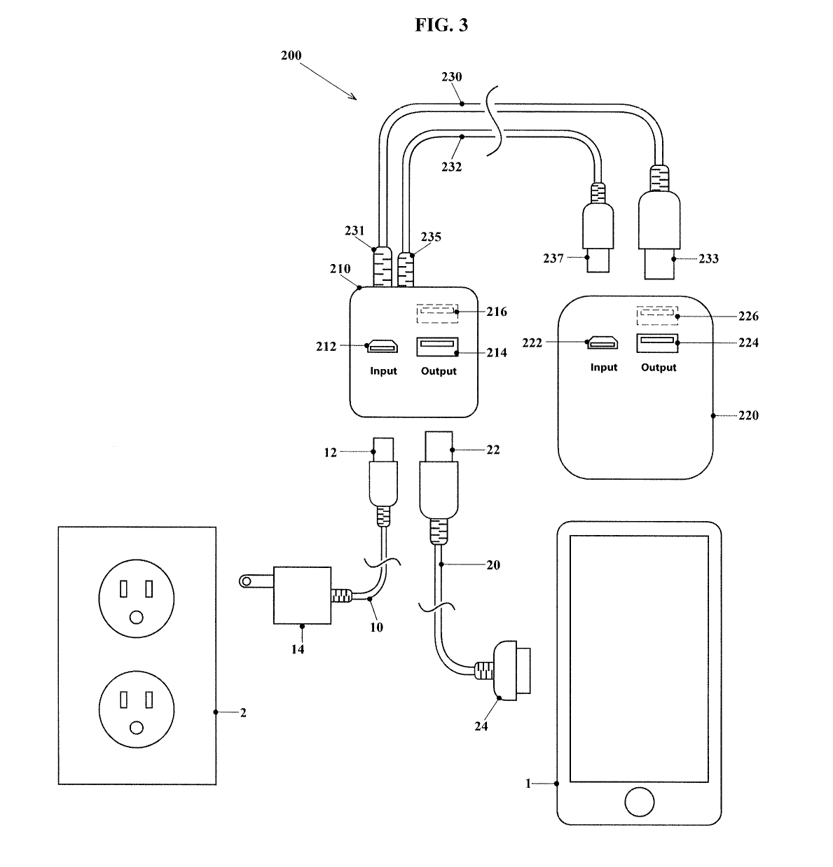

As shown in FIG. 3, the electrical system 200 shown in FIG. 2 may be modified to include additional ports in the battery interface module 210 and the battery 220. In particular, battery interface module 210 may be provided with a second interface output port 216, and battery 220 may be provided with a second battery output port 226. According to the electrical system 200 shown in FIG. 3, a plurality of electronic devices 1 may be simultaneously charged by connecting the devices 1 to the interface output port 214 and the second interface output port 216. Similarly, a plurality of battery interface modules 210 may be connected to the battery 220 by connecting to the battery output port 224 and the second battery output port 226.

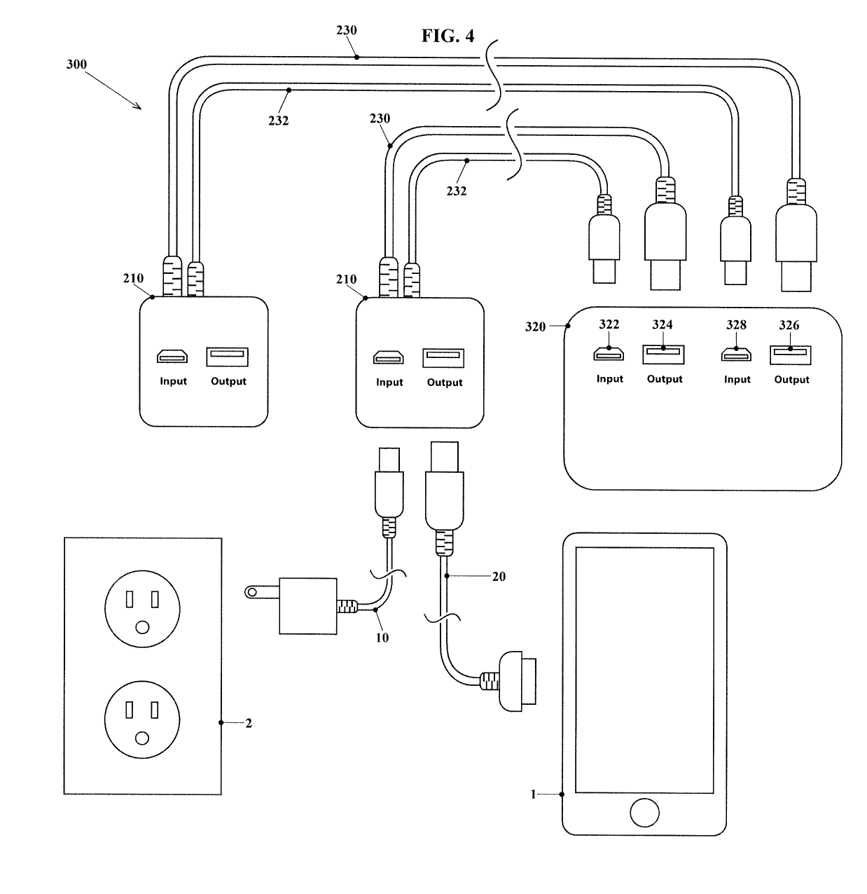

According to the exemplified charging device shown in FIG. 4, an electrical system 300 may include a battery 320 having a plurality of battery input ports 322, 328 and a plurality of battery output ports 324, 326 for providing connections to a plurality of battery interface modules 210. Thus, electrical system 300 allows for an expansion in the number of electronic devices 1 that may be simultaneously charged. In addition, the battery 320 of electrical system 300 may be simultaneously recharged when the plurality of battery interface modules 210 are connected to the battery input ports 322, 328 and to external power supply 2.

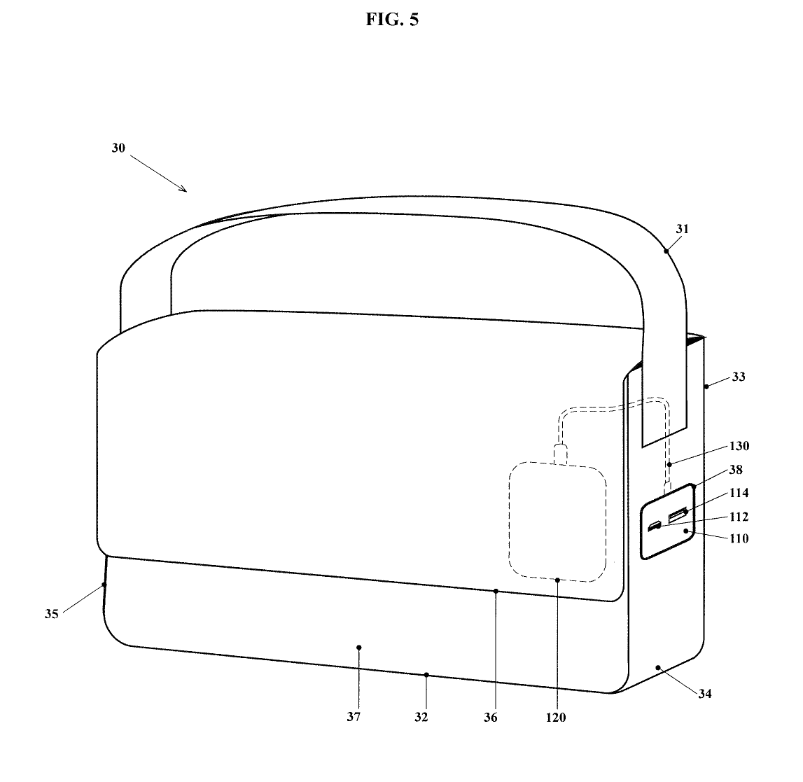

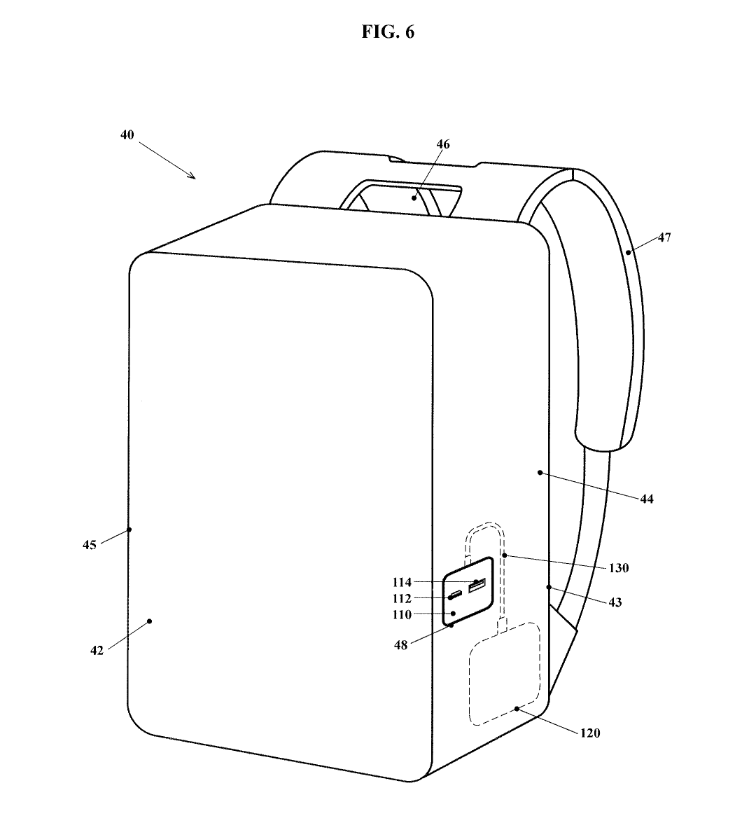

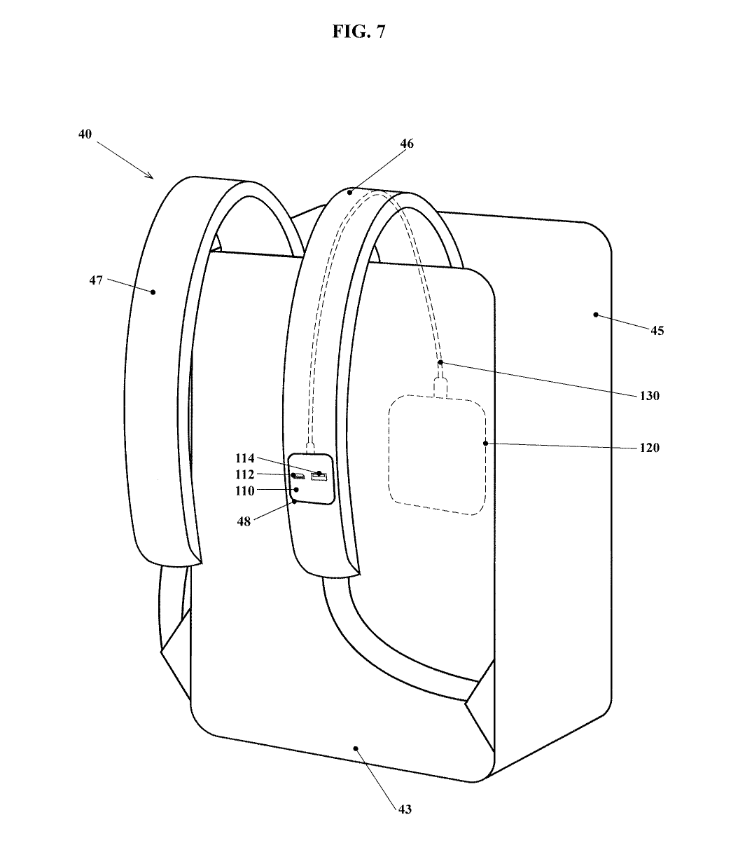

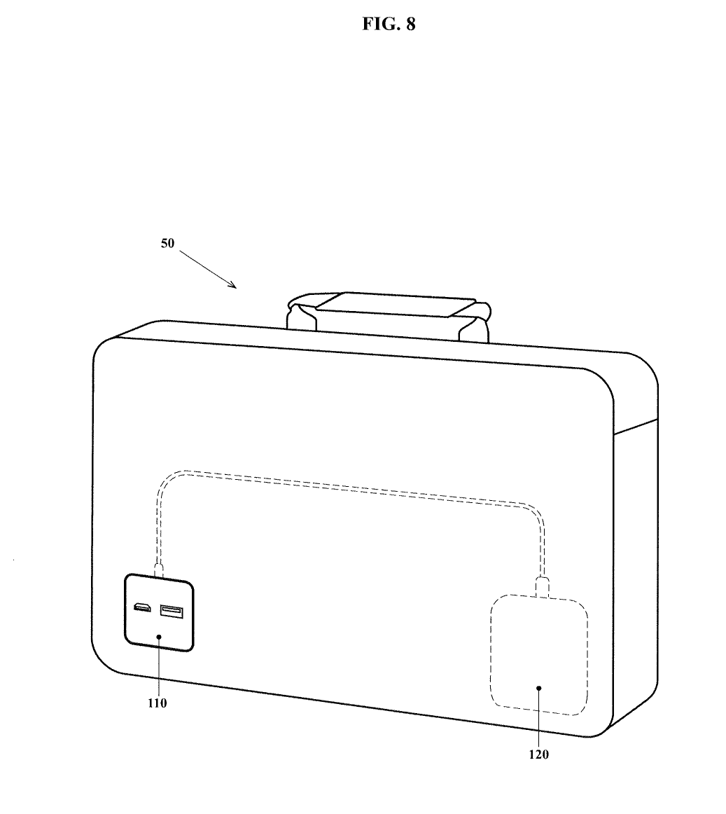

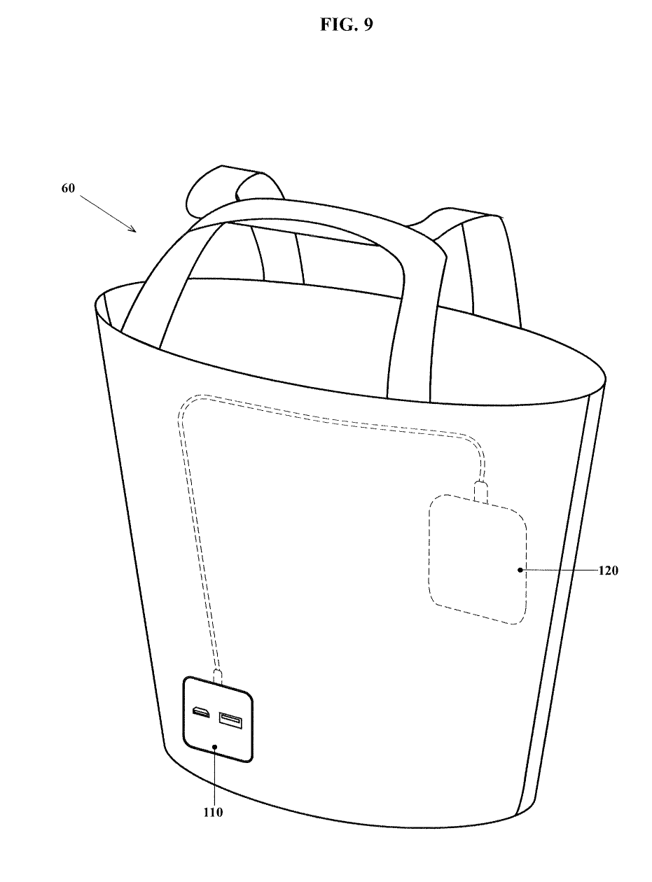

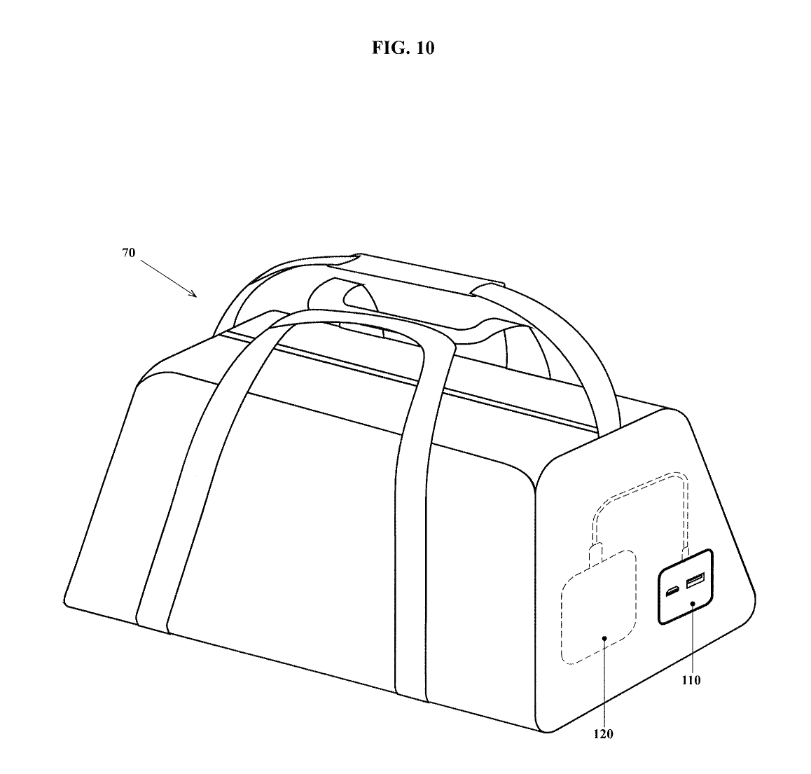

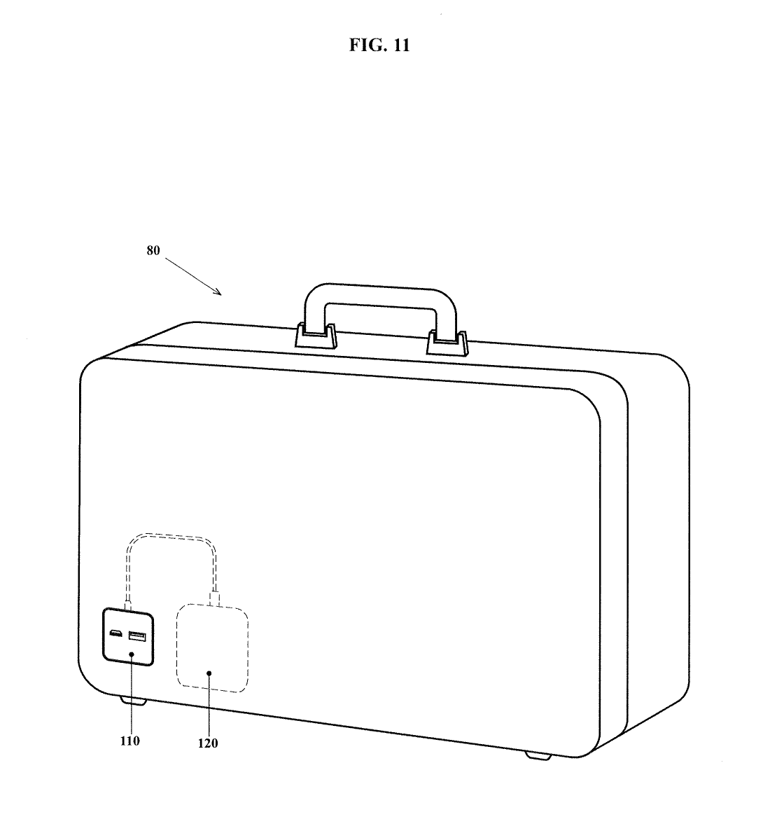

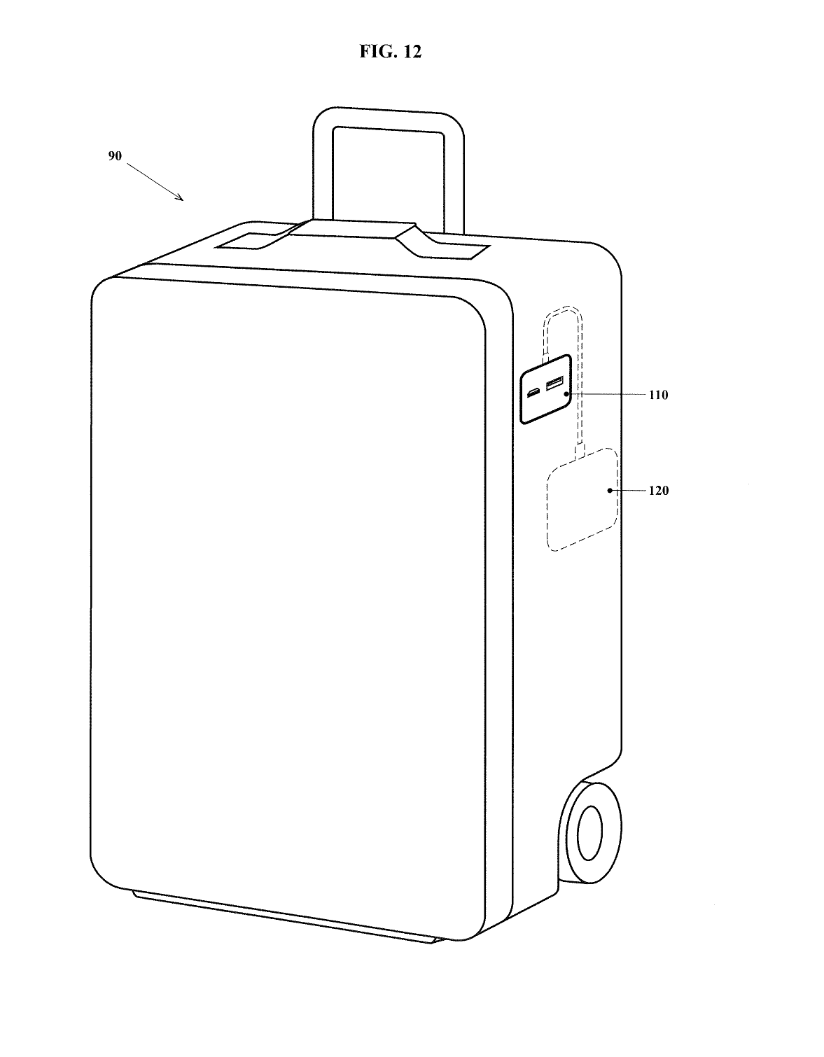

As shown in FIGS. 5-12, embodiments of the electrical systems 100, 200, 300 may be implemented in various types of bags having different volumes and configurations. For example, FIG. 5 shows a diagram of the electrical system 100 provided in a messenger bag 30. FIGS. 6 and 7 show a diagram of the electrical system 100 provided in a backpack 40. FIG. 8 shows a diagram of the electrical system 100 provided in a briefcase 50. FIG. 9 shows a diagram of the electrical system 100 provided in a tote 60. FIG. 10 shows a diagram of the electrical system 100 provided in a duffel bag 70. FIG. 11 shows a diagram of the electrical system 100 provided in a suitcase 80. FIG. 12 shows a diagram of the electrical system 100 provided in a suitcase 90. While the figures depict the various bags including electrical system 100, systems 200 and 300 may also be implemented in the various bags.

As shown in FIG. 5, messenger bag 30 has a front side 32, a rear side 33, a first lateral side 34, and a second lateral side 35. A strap 31 is provided so that a user may carry the bag 30. The bag 30 includes a flap 36 overlapping a front panel 37 to form the front side 32 of the bag 30. A pocket (not shown) is covered by the flap 36 when the flap 36 is positioned over the front panel 37. When in use, the rear side 33 is positioned closer to the user with the front side 32 being positioned away from the user.

As shown in FIG. 5, the bag 30 is provided with an interface opening 38 on the first lateral side 34, and the battery interface module 110 is provided in the interface opening 38 such that the interface input port 112 and the interface output port 114 are positioned on the exterior surface of the first lateral side 34. In this manner, the interface module 110 is accessible from the outside of the bag 30. The cable 130 is provided on the inside of the bag 30 (as indicated by the broken line depiction of cable 130) to connect the interface module 110 to the battery 120, which is also provided inside the bag 30. Thus, a user may access the interface module 110 to charge the battery 120 and/or charge an electronic device without the need to open the bag 30. The interface module 110 and battery 120 may be provided in alternative locations of the bag 30. For example, module 110 and battery 120 may be provided in the front panel 37 of the front side 32 of bag 30 while still providing access to the interface module 110 from the outside of the bag 30. Again, electrical systems 200 and 300 may alternatively be used in the bag 30.

FIGS. 6 and 7 show diagrams of the electrical system 100 in backpack 40. The shell of backpack 40 has a front side 42, a rear side 43, a first lateral side 44, and a second lateral side 45. A first strap 46 and a second strap 47 are provided so that a user may carry the bag 40. The bag 40 is also provided with pockets (not shown). When in use, the rear side 43 is positioned closer to the user with the front side 42 being positioned away from the user.

As shown in FIG. 6, the backpack 40 is provided with an interface opening 48 on the first lateral side 44. The battery interface module 110 is provided in the interface opening 48 on the first lateral side 44 of the bag 40 such that the interface input port 112 and the interface output port 114 are positioned on the exterior surface of the first lateral side 44 of the bag 40. Accordingly, the interface module 110 is accessible from the outside of the backpack 40. The cable 130 is provided on the inside of the backpack 40 (as indicated by the broken line depiction of cable 130) to connect the interface module 110 to the battery 120, which is also provided inside the backpack 40. Thus, a user may access the interface module 110 to charge the battery 120 and/or charge an electronic device without the need to open the bag 40. In the alternative, electrical systems 200 and 300 may also be used in the backpack 40.

As shown in FIG. 7, the backpack 40 is provided with an interface opening 48 on the first strap 46. The battery interface module 110 is provided in the interface opening 48 on the first strap 46 of the bag 40 such that the interface input port 112 and the interface output port 114 are positioned on the exterior surface of the first strap 46 of the bag 40. Accordingly, the interface module 110 is accessible from the outside of the backpack 40. The cable 130 is provided on the inside of the backpack 40 (as indicated by the broken line depiction of cable 130) to connect the interface module 110 to the battery 120, which is also provided inside the backpack 40. In this regard, cable 130 may extend along the interior of the first strap 46 from interface module 110 to the battery 120 provided within the shell of bag 40. Thus, a user may access the interface module 110 to charge the battery 120 and/or charge an electronic device without the need to open the bag 40. In the alternative, electrical systems 200 and 300 may also be used in the backpack 40.

FIGS. 8-12 show alternative types of bags in which the electrical systems 100, 200, 300 may be implemented. The function and implementation of the respective electrical systems 100, 200, 300 in the various bags is the same as described above, and is therefore not repeated. Optionally, bags according to embodiments may be provided with port covers (not shown) that cover the interface input port 112, 212 and the interface output port 114, 214 of the interface module 110, 210.

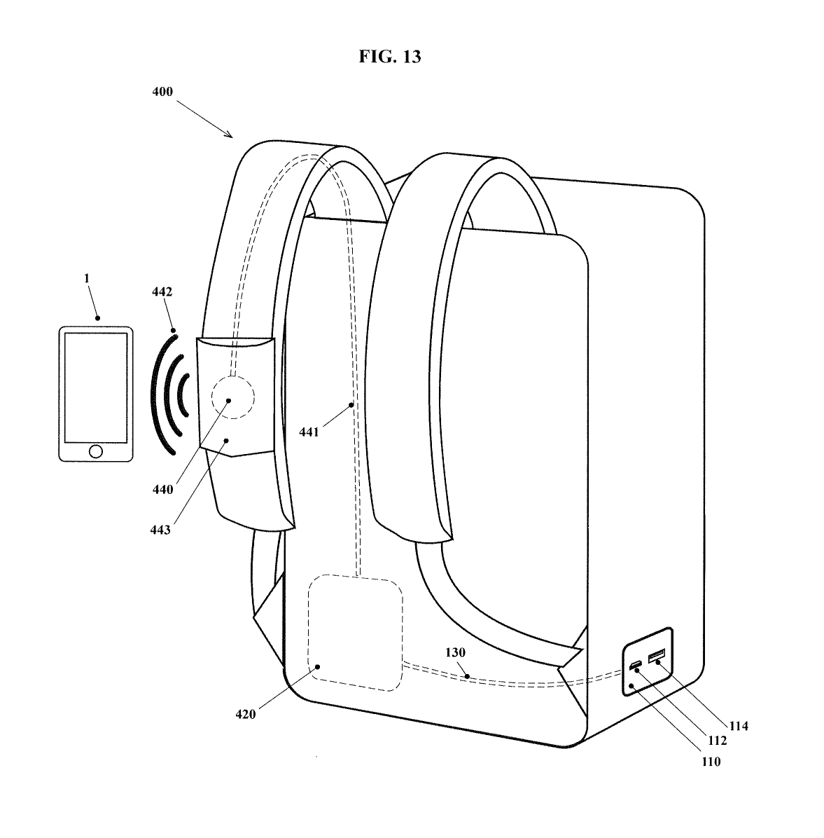

As shown in FIGS. 13-15, embodiments may include capabilities for wireless charging a user's electronic device and/or the battery included within the bag. For example, inductive charging (also known as “wireless charging”) uses an electromagnetic field to transfer energy between two objects. This may be done with a charging station. For example, energy may be sent through an inductive coupling to an electrical device, which can then use that energy to charge batteries of the device or otherwise run the device.

Induction chargers typically use an induction coil (not shown) to create an alternating electromagnetic field from within a charging base station, and a second induction coil (not shown) in the portable electronic device takes power from the electromagnetic field and converts it back into electrical current to charge the electronic device's battery. The two induction coils in proximity combine to form an electrical transformer.

According to the embodiments shown in FIGS. 13-15, the charging experience for the user may be more convenient and less obtrusive than embodiments that provide wired connections. As shown in FIG. 13, bag 400 is capable of wirelessly charging an electronic device 1. Bag 400 includes a battery interface module 110 having interface input port 112 and interface output port 114, as previously described. Interface module 110 is connected to battery 420 by cable 130. An output interface 440 is electrically connected to the battery 420 by cable 441. Output interface 440 is integrated with wireless charging technology, such as inductive charging, such that output interface 440 generates an electromagnetic field 442 to wirelessly charge electronic device 1. The output interface 440 is positioned in a convenient location on the bag 400 so that the user could easily charge an electronic device 1 such as a mobile phone or tablet. In the case of a mobile phone, for example, the user may place the phone in an accessible pocket 443 or clip, snap or magnetically attach the phone to the bag 400 in a location that is in proximity to the output interface 440, and the device 1 would be automatically charged using the power stored in the battery 420 inside the bag 400. In this way, the user's experience would be simple and intuitive. Whenever the device 1 is stowed in this charging location (pocket 443), the device 1 would automatically charge without requiring any additional steps from the user and without the encumbrance of any wires or connectors. As shown in FIG. 13, the pocket 443 may be provided on a strap of bag 400, or any other suitable location on the bag 400.

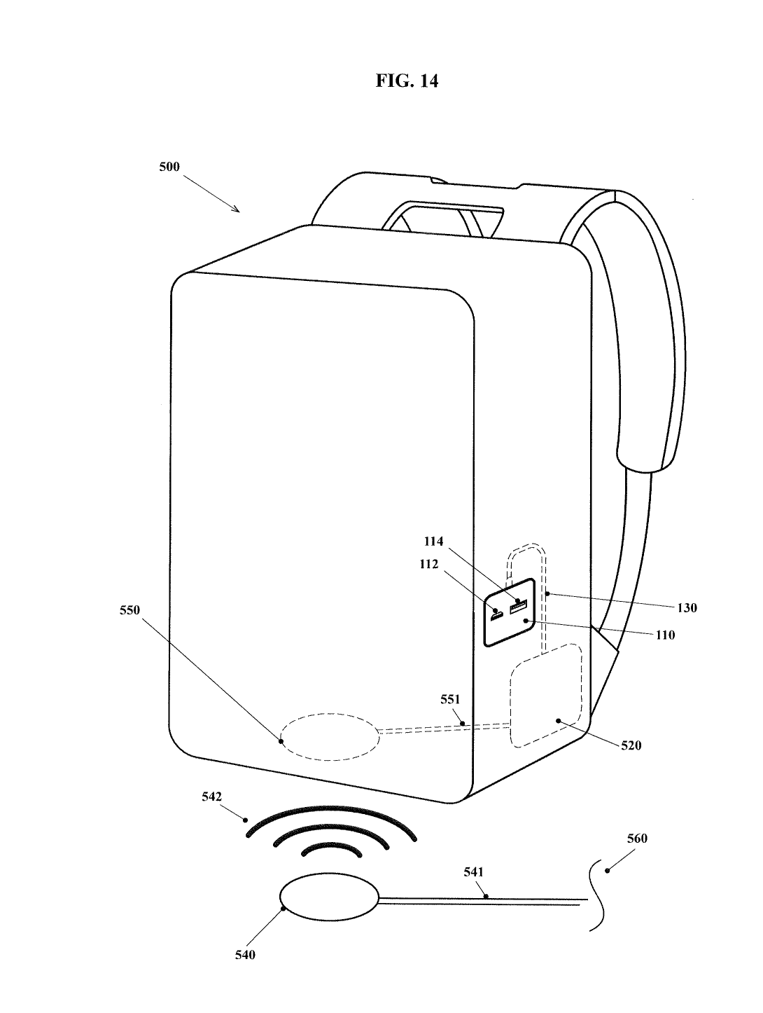

As shown in FIG. 14, another embodiment includes a bag 500 containing a battery 520 electrically connected to an input interface 550 by way of cable 551. Input interface 550 allows the user to wirelessly charge the battery 520 and charge an electronic device (not shown) using the power stored in the battery 520. In one use case, the user may place the input interface 550 of bag 500 on or in close proximity to a charging station 540, which is connected to a power source 560 via cable 541. Charging station 540 includes wireless charging technology such that charging station 540 may generate an electromagnetic field 542. When in proximity to the wireless charging station 540, input interface 550 may convert the energy from electromagnetic field 542 to electrical energy, and automatically charge the battery 520 inside of bag 500. When the user removes the bag 500 from charging station 540 to travel to a next destination, the battery 520 inside of the bag 500 will be fully or partially charged.

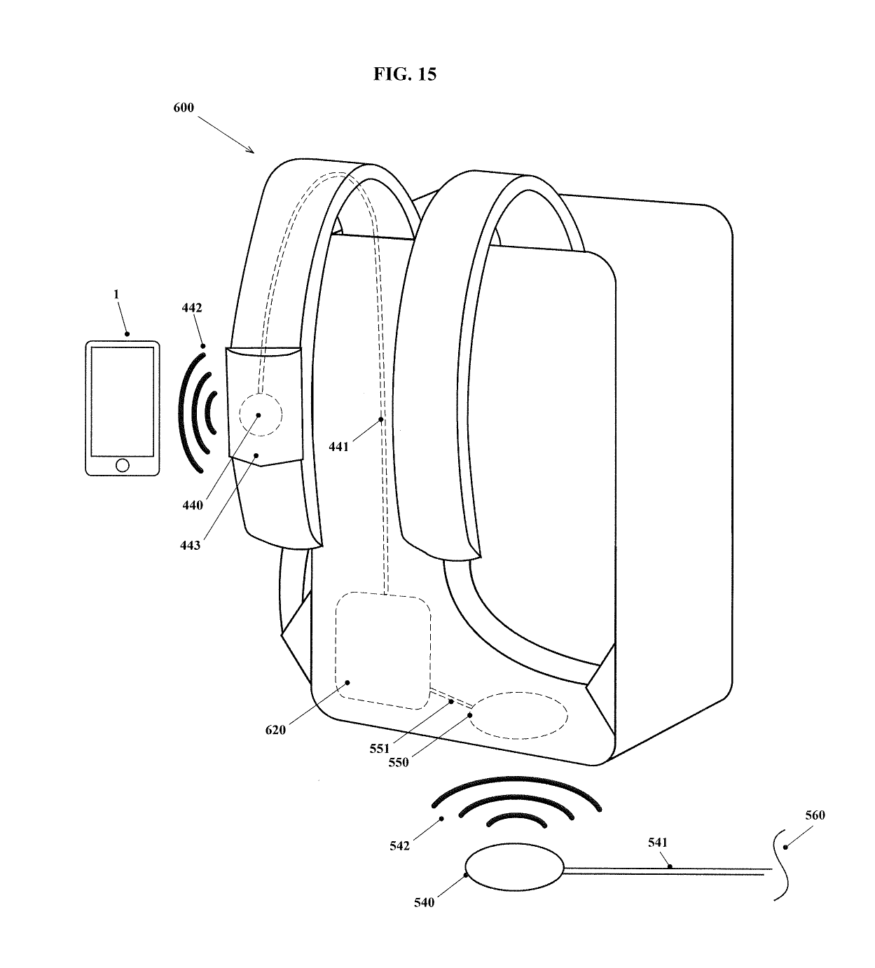

As shown in FIG. 15, bag 600 may be provided with both output interface 440 for wirelessly charging electronic device 1 and input interface 550 for wirelessly charging battery 620 provided in bag 600. Thus, ports and connectors for wired connections to either an external power source 560 or an electronic device 1 are not needed in the bag 600 shown in FIG. 15. Rather, charging of an electronic device 1 occurs when the device 1 is brought into proximity with the output interface 440. For example, electronic device 1 may be held in place in pocket 443 provided on a strap of the bag 600 such that the device 1 may be in close proximity to the output interface 440. Similarly, charging of battery 620 occurs when input interface 550 is brought into proximity with charging station 540. Thus, openings in the bag 600 are not needed to establish an electrical connection through either output interface 440 or input interface 550 to charge electronic device 1 or battery 620, respectively.

While the wireless charging capabilities shown in FIGS. 13-15 are shown as being implemented on a backpack-type bag, they may also be implemented on different types of bags. In addition, bag 600 may be provided with an attachment mechanism (e.g., pocket 443) on its exterior for attaching the electronic device 1 to the bag 600 so that the device 1 is in proximity to the wireless output interface 440 of the bag 600. The attachment mechanism may be configured such that the electronic device 1 is quickly removable so as to provide convenient access to interface with the device 1. For example, attachment mechanism may include but is not limited to a pocket 443, magnet(s), a clip, snap, or other suitable mechanical attachment, or non-permanent adhesive (e.g., Velcro).

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. A charging device comprising:
a bag including an interface opening;
a battery disposed within the bag; and
a battery interface module adapted to be electrically coupled to the battery, the battery interface module having an interface input port for connecting to an external power source and an interface output port for connecting to an electronic device,
wherein the battery interface module is disposed within the interface opening of the bag such that the input port and the output port are accessible from an exterior of the bag.

2. The charging device of claim 1, wherein the battery interface module is electrically coupled to the battery by an internal cable that is fixed to the battery interface module and the battery.

3. The charging device of claim 1, wherein the battery interface module is removably connected to the battery by an internal cable.

4. The charging device of claim 3, wherein the battery includes a battery input port and a battery output port, and the internal cable is adapted to connect the battery interface module to the battery via the battery input port and the battery output port.

5. The charging device of claim 4, wherein the battery includes a plurality of battery input ports and a plurality of output ports such that a plurality of battery interface modules can be electrically connected to the battery.

6. The charging device of 1, further comprising
a second interface opening; and
a second battery interface module having a second interface input port for connecting to the external power source and a second interface output port for connecting to the electronic device, the second battery interface module being disposed within the second interface opening such that the second interface input port and the second interface output are accessible from the exterior of the bag.

7. The charging device of claim 1, wherein the interface input port is adapted to be connected to an alternating current power source.

8. The charging device of claim 1, wherein the bag is selected from the group consisting of a backpack, a messenger bag, a briefcase, a duffel bag, a sleeve case, a suitcase, a garment bag, a tote, and a trunk.

9. The charging device of claim 1, wherein the battery interface module further includes a status indicator that displays information related to the battery.

10. The charging device of claim 1, wherein the bag includes:
a shell that defines an interior compartment; and
a strap,
wherein the interface opening is formed in the shell of the bag such that the battery interface module is provided in the shell of the bag.

11. The charging device of claim 1, wherein the bag includes:
a shell that defines an interior compartment; and
a strap,
wherein the interface opening is formed in the strap of the bag such that the battery interface module is provided in the strap of the bag.

12. The charging device of claim 1, wherein the bag is a backpack including:
a shell that defines an interior compartment;
a first strap; and
a second strap,
wherein the interface opening is formed in a surface of the first strap of the bag that is adapted to be outwardly facing relative to a user when the bag is being worn, such that the battery interface module is provided in the first strap of the bag.

13. A charging device comprising:
a bag;
a battery disposed within the bag;
an input interface electrically connected to the battery, the input interface being configured to electrically connect to an external power source; and
an output interface electrically connected to the battery and configured to charge an electronic device.

14. The charging device of claim 13, wherein the input interface is configured to wirelessly connect to the external power source.

15. The charging device of claim 13, wherein the output interface is configured to wirelessly connect to the electronic device.

16. The charging device of claim 15, wherein the input interface is configured to wirelessly connect to the external power source.

17. The charging device of claim 13, further comprising
an attachment mechanism for removably attaching the electronic device to an exterior of the bag in a location in proximity to the output interface.
